(19) United States
(12) Patent Application Publication
(10) Pub. No.: US 2025/0202818 A1
(43) Pub. Date: Jun. 19, 2025

(54) ENABLING DIFFERENTIATED MULTI-SEGMENT CLOUD SECURITY FOR TENANTS ON A MULTI-TENANT EDGE DEVICE

(71) Applicant: Cisco Technology, Inc., San Jose, CA (US)

(72) Inventors: Avinash Shah, Pleasanton, CA (US); Ganesh Devendrachar, Milpitas, CA (US); Pritam Baruah, Fremont, CA (US); Ajeet Pal Singh Gill, Fremont, CA (US); Laxmikantha Reddy Ponnuru, San Ramon, CA (US)

(21) Appl. No.: 18/541,382

(22) Filed: Dec. 15, 2023

(51) Int. Cl. H04L 45/7453; H04L 9/40; H04L 12/46; H04L 45/76

(52) U.S. Cl. CPC H04L 45/7453; H04L 12/4633; H04L 45/76; H04L 63/0272

(57) ABSTRACT

Edge router may receive, from a tenant of a multi-tenanted network, a request to access a Secured Internet Gateway (SIG) service associated with a cloud provider. The edge router may access one or more reference tables and add one or more hash entries to the one or more reference tables. The one or more hash entries includes one or more identifiers associated with the request. The edge router may transmit the request to the SIG service. The edge router may receive a response from the SIG service and may transmit the response to the tenant of the multi-tenanted network according to the one or more hash entries of the one or more reference tables.

### TECHNICAL FIELD

The present technology pertains to multi-tenanted networks, and, more specifically, to maintaining segmentation in a multi-tenanted network while routing traffic to Secured Internet Gateways.

### BACKGROUND

In multi-tenant networks, many customers want to make use of some Secured Internet Gateway (SIG) services for their network (e.g., Cisco Umbrella, Zscalar, etc.) via Secure Service Edge (SSE) instances. To do so, a device may transmit a request, which may be received by a VPN edge router, transmitted to a transport VPN edge router, then transmitted to the SIG service via a transport tunnel. In these multi-tenant networks, there could be multiple network segments on the customer sites, such as segments dedicated to different departments (e.g., engineering, HR, finance, etc.) or access levels (e.g., employee, guest, etc.). Customers may want to differentiate services from cloud security providers for each of these segments. Typically, transport connections (e.g., IPsec on a WAN) between the device and the SIG service is shared among all the segments, and there is no preservation of segmentation information on the transport connection.

### BRIEF DESCRIPTION OF THE DRAWINGS

To easily identify the discussion of any particular element or act, the most significant digit or digits in a reference number refer to the figure number in which that element is first introduced.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a high-level network architecture according to some aspects of the present disclosure.

FIG. 2 illustrates an example diagram for a multi-tenanted network accessing SIG services according to some aspects of the present disclosure.

FIG. 3 illustrates an example diagram of a multi-tenanted network where tenant traffic is sent over a unique transport tunnel.

FIG. 4 illustrates an example diagram of a multi-tenanted network utilizing high-availability transport tunnels according to some aspects of the present disclosure.

FIG. 5 illustrates an example diagram of a multi-tenanted network utilizing a common transport tunnel for one or more tenants according to some aspects of the present disclosure.

FIG. 6 illustrates an example diagram of a multi-tenanted network utilizing a unique transport VPN for each tenant of the network according to some aspects of the present disclosure.

FIG. 7 illustrates an example routine for maintaining segmentation in a multi-tenanted network according to some aspects of the present disclosure.

FIG. 8 illustrates an example network device according to some aspects of the present disclosure.

FIG. 9 shows an example of a computing system for implementing certain aspects of the present technology, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

### OVERVIEW

The present disclosure includes a computer-implemented method for differentiated multi-segmented cloud security. In one aspect, an edge router may receive, from a tenant of a multi-tenanted network, a request to access a Secured Internet Gateway (SIG) service associated with a cloud provider. The edge router may access one or more reference tables and add one or more hash entries to the one or more reference tables. The one or more hash entries includes one or more identifiers associated with the request. The edge router may transmit the request to the SIG service. The edge router may receive a response from the SIG service and may transmit the response to the tenant of the multi-tenanted network according to the one or more hash entries of the one or more reference tables.

In another aspect, the request is transmitted through a unique transport tunnel, and where the one or more identifiers include at least a source Internet Protocol (IP) address and a transport tunnel identifier. In another aspect, the request is transmitted through a high availability (HA) transport tunnel pair, and where the one or more identifiers include at least an HA transport tunnel pair identifier. In another aspect, the request is transmitted through a common transport tunnel, and where the one or more reference tables include a port entry translate table. In another aspect, the one or more reference tables are maintained for a transport virtual private network (VPN) transmitting the request to the SIG service. In another aspect, the one or more hash entries are removed from the one or more reference tables after a duration of time. In another aspect, the one or more hash entries are added to the one or more reference tables using a multiplexer. In another aspect, the one or more hash entries are extracted from the one or more reference tables using a demultiplexer.

Systems are described herein for differentiated multi-segmented cloud security. The systems may comprise one or more processors and a memory storing instructions that, as a result of being executed by one or more processors, cause the system to perform any of the aforementioned methods. Non-transitory computer-readable storage media are described herein that store instructions therein that, as a result of being executed by one or more processors, cause the one or more processors to perform any of the aforementioned methods. Other technical features may be readily apparent to one skilled in the art from the following figures, descriptions, and claims.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

One or more of the examples of the present disclosure may uniquely identify and forward communications to respective VPNs/segments, per tenant, in order to maintain the segmentation on the multi-tenant network. Maintaining the segmentation on the multi-tenanted network assists in ensuring cloud security between tenants and/or networks associated with tenants. The disclosed technology implements network segmentation on a multi-tenanted network while utilizing Secured Internet Gateway (SIG) services on the network. For each tenant on the network, there may be multiple segments (e.g., human resources, engineering, accounting, guest, etc.) attempting to access certain SIG services. These segments may each have varying security policies. Often, transport connections used to access a SIG service (e.g., via an edge router) are shared amongst all segments of a tenant and there is no preservation of segmentation for an individual tenant. In this manner, the technology disclosed herein discusses a variety of implementations for one or more embodiments to implement the preservation of segmentation for a tenant so the tenant can maintain proper security policies.

In the multi-tenanted network scenario, multiple tenants may access a SIG service. In such a deployment, there is a need to mux/demux packets from multiple network segments into one common transport link (e.g., the link between an edge device via a common transport VPN and the SIG service) per tenant. The returning traffic received at the common transport VPN may be uniquely identified and forwarded to respective VPNs and/or segments, per tenant. In some examples, the traffic from segments of tenants may have overlapping Internet Protocol (IP) address. Edge devices should enable forwarding traffic for overlapping IP addresses across tenants. Further, there may control and/or management traffic that should be differentiated from typical client traffic, such as tunnel health and/or path trackers.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

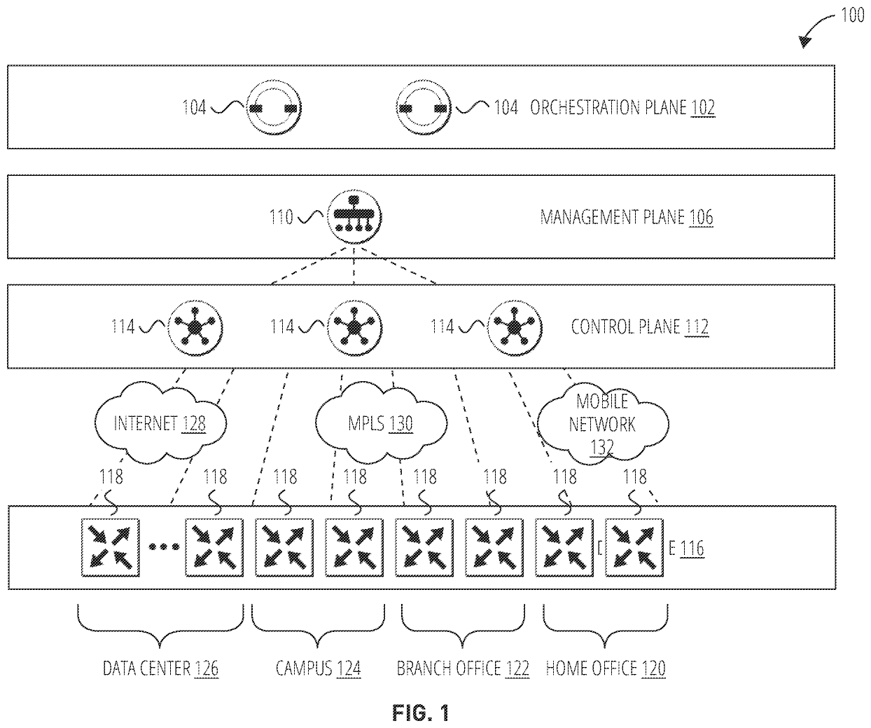

FIG. 1 illustrates an example of a network architecture 100 according to some aspects of the present disclosure. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include one or more physical or virtual network management appliances 110. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances 114. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as via one or more internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as the edge network devices 118.

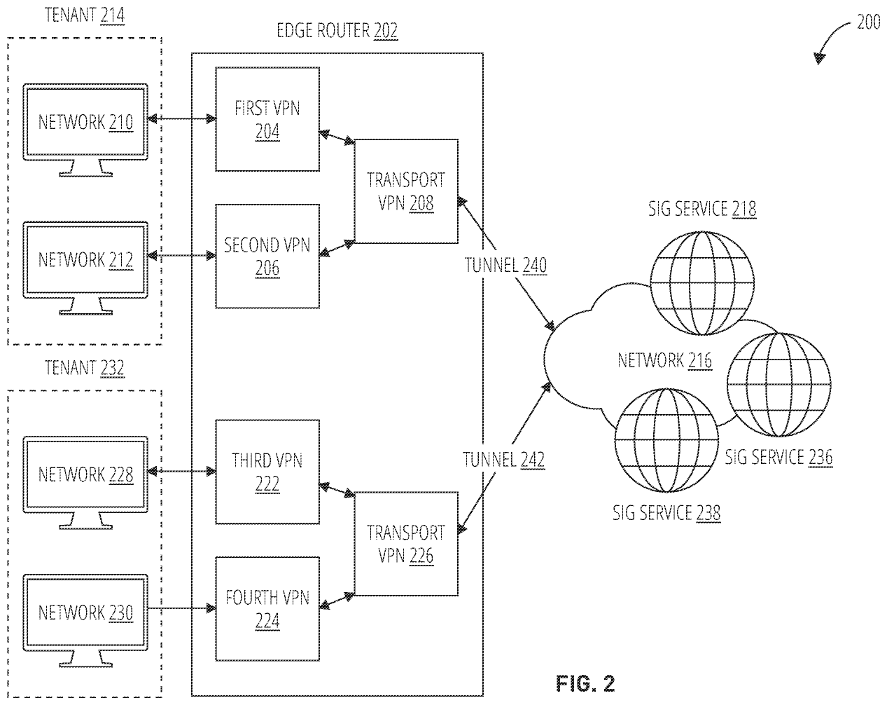

FIG. 2 illustrates an example diagram for a multi-tenanted network accessing SIG services according to aspects of the present disclosure. In this example, tenant 214 may be associated with one or more segments (e.g., network 210 and network 212). The one or more segments may access a multi-tenanted network (e.g., network 216) through virtual private networks (VPNs) (e.g., first VPN 204 and second VPN 206). The one or more segments may each be associated with different aspects and/or groups of tenant 214, including, but not limited to, departments, groups, buildings, floors, guest status, employment status, ranking, clearance, office, device, user, any combination thereof, or the like. For example, network 210 may be associated with the engineering department and may access network 216 via first VPN 204.

In addition to tenant 214, network 216 may also include tenant 232. Similar to tenant 214, tenant 232 may include one or more segments (e.g., network 228 and network 230), which may be associated with respective VPNs (e.g., third VPN 222 and fourth VPN 224). Tenant 214 and tenant 232 may be associated with a “transport” VPN, which may facilitate the transmission of traffic from a tenant to a network, thereby maintaining segmentation between the tenants on a multi-tenanted network. For example, tenant 214 may be associated with transport VPN 208, which may receive and forward traffic between segments of tenant 214 and network 216, using a transport tunnel (e.g., tunnel 240). As another example, tenant 232 may be associated with transport VPN 226, which may receive and forward traffic between segments of tenant 232 and network 216, using a transport tunnel (e.g., tunnel 242). The transport tunnels (e.g., tunnel 240 and tunnel 242) may route traffic to requested SIG services (e.g., SIG service 218, SIG service 236, and SIG service 238), and may attempt to route traffic back to a respective segment. The requested SIG services may be associated with a cloud service stored at a cloud provider. The requested SIG services may provide security for the cloud service stored at the cloud provider.

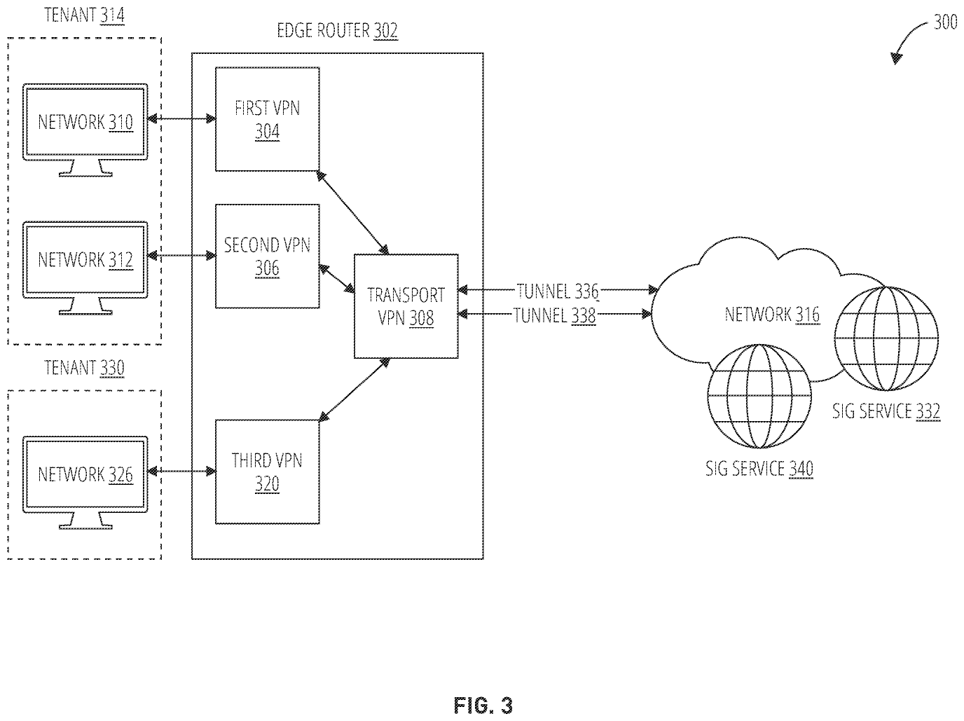

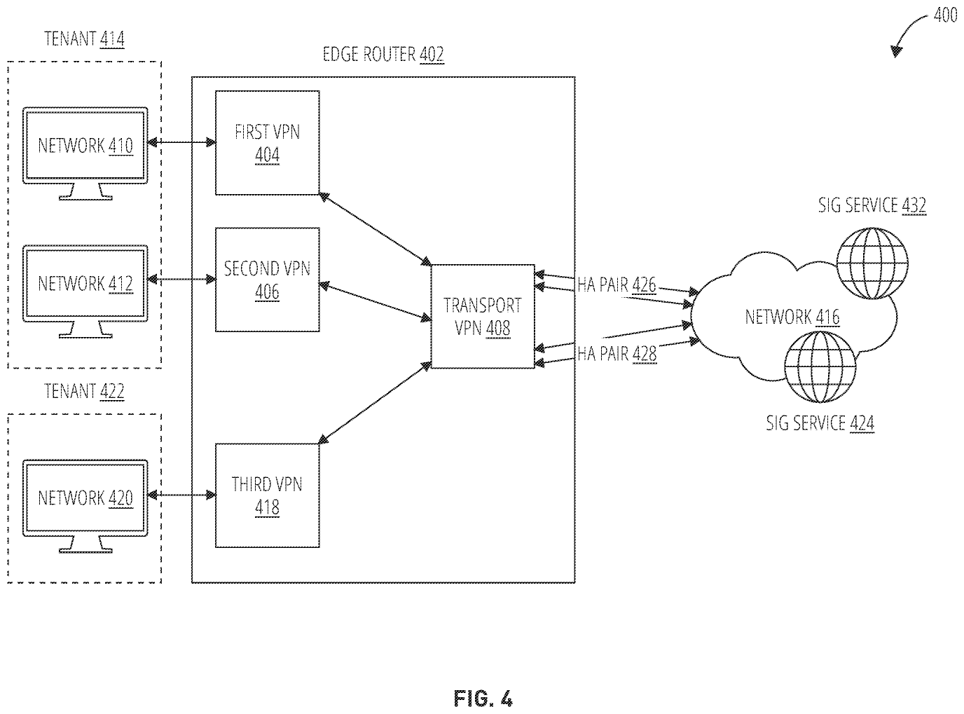

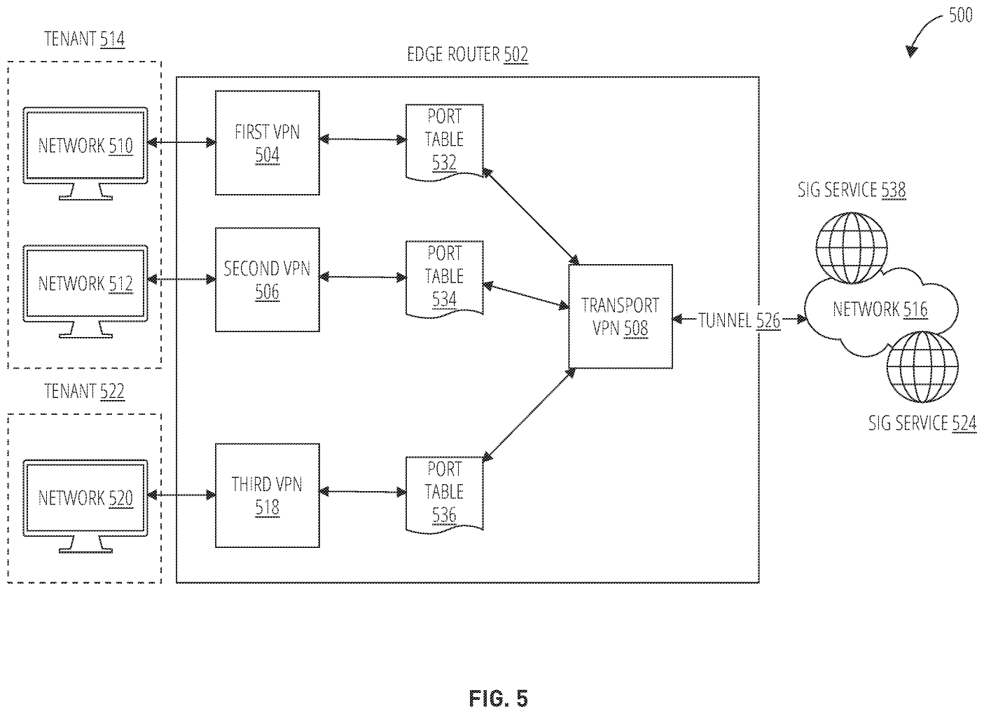

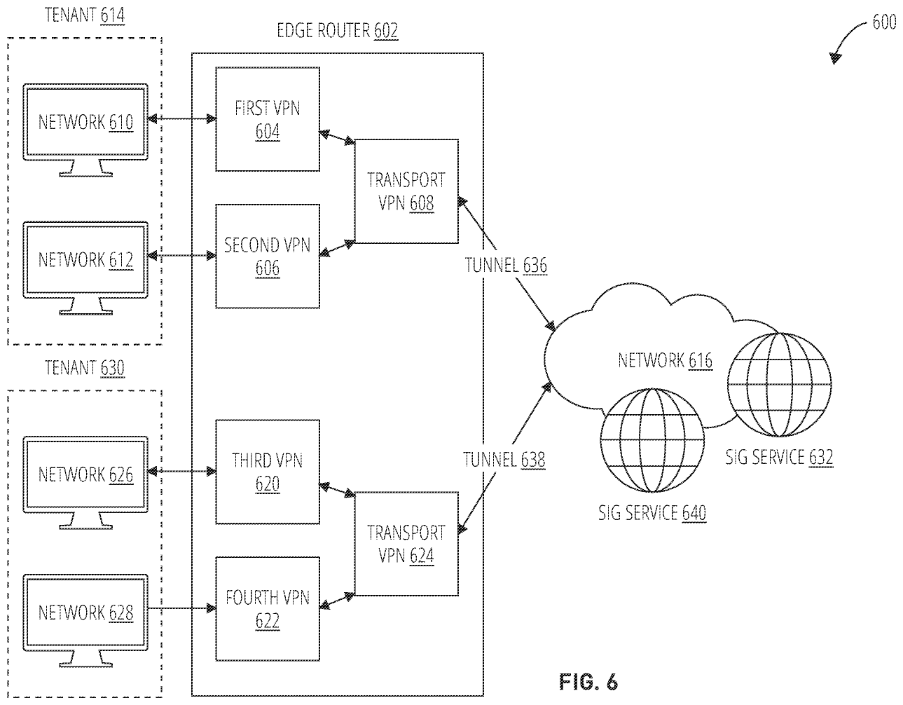

Although the system 200 described in FIG. 2 may allow for segmentation between tenants, the system 200 may not provide complete segmentation between segments of a particular tenant. Additionally, in some examples, tenants may share a transport VPN, which may not provide complete segmentation between tenants. For example, traffic from network 228 and network 230 may be associated with overlapping IPs, thereby creating an issue when routing returning traffic back to the segments from a SIG service (e.g., SIG service 218, SIG service 236, and SIG service 238). As another example, traffic from tenant 214 and tenant 232 may both be routed through transport VPN 208. The following figures, FIG. 3, FIG. 4, FIG. 5, and FIG. 6, demonstrate example solutions for maintaining segmentation between segments of a tenant and individual tenants as illustrated in FIG. 2.

FIG. 3 illustrates an example diagram of a multi-tenanted network where tenant traffic is sent over a unique transport tunnel. System 300 illustrates requests from tenants of a multi-tenanted network 316 to access SIG services (e.g., SIG service 332 and/or SIG service 340) via edge router 302. For example, traffic associated with network 310 of tenant 314 may be transmitted by first VPN 304 to transport VPN 308, then transmitted via tunnel 336 to network 316. In a similar manner, traffic associated with network 312 of tenant 314 may be transmitted by second VPN 306 to transport VPN 308, then transmitted via tunnel 338 to network 316. Traffic associated with network 326 of tenant 330 may be transmitted to third VPN 320 then to transport VPN 308, which may then transmit the traffic via tunnel 338 to network 316. Network 316 may route traffic to an appropriate SIG service (e.g., SIG service 332 and/or SIG service 340). In this case, overlapping IPs may occur across network segments (e.g., network 310 and network 312) and/or across VPNs (e.g., first VPN 304 and second VPN 306).

In some examples, a multiplexer/demultiplexer table (mux/demux table) may be implemented at, before, and/or immediately following transport VPN 308. The table may be stored in a location accessible to edge router 302 and/or transport VPN 308, including, but not limited to, local storage, a public cloud, a private cloud, a database, and any other method of storing and maintaining a mux/demux table. In some examples, outgoing traffic may initiate an entry in the mux/demux table at transport VPN 308. The entry may be a hash entry generated using a hashing algorithm, including, but not limited to, Message Digest (MD) 5, Secure Hash Algorithm (SHA) 1, SHA-2, Microsoft LAN Manager, NTLM, or a hashing function, such as the division method, the mid square method, the folding method, and the multiplication method.

Outgoing traffic may generate a hash entry and add the hash entry to the mux/demux table. The hash entry may be added with a key that may include the IP address of the source and a transport tunnel identifier. For example, the key may include a reference to network 310 and/or first VPN 304, and tunnel 336. The result of a hash function associated with the mux/demux table and the key may be referred to as a VPN identifier. Return traffic from a SIG service (e.g., SIG service 340 and SIG service 332) may include a destination IP and the transport tunnel identifier, which may be used as a key to lookup the VPN identifier from where the associated flow originated. The return traffic may be demuxed to the VPN identifier. Using the VPN identifier, edge router 302 may route the return traffic to the correct source. The entries within the mux/demux table may be purged periodically (e.g., after a certain length of time, after a certain amount of entries, after a storage or processing threshold is reached, etc.).

For example, network 310 may transmit a request to access SIG service 340. The request may be received by first VPN 304 and transmitted to transport VPN 308. At transport VPN 308, a hash entry may be generated, comprised of at least the IP address of network 310 and an identifier associated with tunnel 336 (and/or the transport tunnel associated with tenant 314), thereby generating a VPN identifier. Tunnel 336 may transmit the request to SIG service 340. SIG service 340, upon receipt of the request, may transmit a response to network 310. The response may be transmitted via tunnel 336. Upon receipt of the response at transport VPN 308, a destination IP included in the response and the identifier associated with tunnel 336 may be used to identify the VPN identifier generated with the initial request from network 310. The response may be routed according to the VPN identifier. In some examples, the hash entry may be generated using an IP address associated with first VPN 304, in lieu of or in addition to network 310. This method results in an increased distinction and segmentation between tenants and segments of tenants.

FIG. 4 illustrates an example diagram of a multi-tenanted network utilizing high-availability transport tunnels according to some aspects of the present disclosure. System 400 may illustrate traffic from tenant 414 and/or tenant 422 transmitted via edge router 402 to network 416. High-availability transport tunnels may be used in some deployments of edge routers, such as edge router 402 shown in system 400. High-availability (HA) transport tunnels include an “active” and a “backup” transport tunnel, such that the “backup” transport tunnel can take over for the “active” tunnel if the “active” tunnel fails. In this scenario, using a similar system and method described in FIG. 3 and system 300, an additional number of hash entries may be included in a mux/demux table when the “backup” tunnel takes over for the “active” tunnel (until the “active” tunnel entries are purged). Additional implementations are necessary to avoid excessive and redundant entries in the hash table.

HA pairs may be associated with respective tenants and/or networks. For example, network 410 of tenant 414 may transmit a request to first VPN 404 (or network 412 may transmit a request to second VPN 406) to access a SIG service (e.g., SIG service 432 and/or SIG service 424), which may be transmitted to transport VPN 308 and subsequently transmitted to network 416 via HA pair 426. In a similar manner, network 420 of tenant 422 may transmit a request to third VPN 418 to access a SIG service, which may be transmitted to transport VPN 408 and subsequently transmitted to network 416 via HA pair 428.

In the HA transport tunnel scenario, as shown in system 400, network 410 of tenant 414 may transmit a request to first VPN 404 to access SIG service 424. First VPN 404 may transmit the request to transport VPN 408, which may instantiate an entry in a mux/demux table at, before, or immediately following transport VPN 408. A hash entry associated with the mux/demux table may be generated with a HA pair identifier associated with a HA pair associated with tenant 414. In this example, the HA pair identifier may reference HA pair 426. In some examples, the hash entry may be generated with the HA pair identifier, the IP address of network 410 (and/or first VPN 404), and/or an identifier associated with a transport tunnel associated with tenant 414 (e.g., a tunnel of HA pair 426). The result of the hash entry may generate a VPN identifier. Transport VPN 408 may transmit the request to SIG service 424. SIG service 424 may transmit a response and the response may be transmitted to transport VPN 408 via HA pair 426. A tunnel identifier (e.g., a reference to an “active” tunnel of HA pair 426) associated with the response may be converted to an HA pair identifier, and the HA pair identifier and a destination IP address included in the response may be used as a key to lookup the VPN identifier. The VPN identifier may be used to transmit the response back to network 410.

In some examples, the mux/demux table may initiate a purge when an HA transport tunnel pair switches from “active” to “backup” (or vice versa). For example, when an active tunnel of an HA transport tunnel pair fails, and the backup tunnel begins transmitting communications between tenants and SIG services, the mux/demux table may automatically remove all hash entries that contain a tunnel identifier associated with the active tunnel. This may reduce the amount of unnecessary and/or redundant entries in the mux/demux table. In this example, the addition of the HA pair identifier may be unnecessary.

FIG. 5 illustrates an example diagram of a multi-tenanted network utilizing a common transport tunnel for one or more tenants according to some aspects of the present disclosure. System 500 of FIG. 5 may include one or more tenants transmitting requests to network 516 via edge router 502 using a single transport tunnel 526. For example, network 510 of tenant 514 may transmit a request to access a SIG service (e.g., SIG service 538 and/or SIG service 524), which may be transmitted to first VPN 504, then to network 516 via transport VPN 508 and tunnel 526. In a similar manner, network 512 of tenant 514 may transmit a request to access a SIG service, which may be transmitted to second VPN 506, then to network 516 via transport VPN 508 and tunnel 526. Network 520 of tenant 522 may transmit a request to access a SIG service, which may be transmitted to third VPN 518, then to network 516 via transport VPN 508 and tunnel 526.

To maintain segmentation in the scenario demonstrated in system 500, a set of port tables may be incorporated into edge router 502. A port table may be associated with a VPN (e.g., first VPN 504 may be associated with port table 532, second VPN 506 may be associated with port table 534, and third VPN 518 may be associated with port table 536). The set of port tables may be in addition to the mux/demux table, as described in FIGS. 2, 3, and 4. The set of port tables may store a translated port entry associated with a VPN (e.g., port table 532 may store the translated port entry for first VPN 504), while the mux/demux table may utilize a source IP and a source port as a hash entry key. The set of port tables may detect when collisions happen (e.g., traffic routed to incorrect networks) due to duplicate source port identifiers, and then the set of port tables may translate the duplicated source port identifiers to a new source port identifier.

For example, network 510 may transmit a request to access SIG service 538, and the request may be associated with a source port identifier. First VPN 404 may transmit the request to transport VPN 508, which may lookup an entry in the mux/demux table using the source port identifier and a source IP address (e.g., IP address associated with network 510 and/or first VPN 504). If an entry does not exist, then a new hash entry is input using a key comprised of the source port identifier and the source IP address, resulting in a VPN identifier.

In some examples, the source port identifier may already exist in an entry in the mux/demux table, indicating a possible collision (e.g., the potential of transmission being incorrectly transmitted to segments of tenant networks and/or tenants themselves). In this example, a new source port identifier may be allocated from a pre-defined common port number pool. Thus, the source port identifier may be translated to the new source port identifier. A new hash entry may be added to the mux/demux table using the new source identifier and the source IP address, generating the VPN identifier. Additionally, a flag may be set, indicating that the source port identifier has been translated to the new source identifier. The flag may initiate an entry to be added to port table 532 that may associate the source port identifier and the new port identifier, such that incoming traffic may be transmitted accordingly.

For future transmissions, requests from network 510 may be automatically associated with new port identifier. However, in some examples, the new port identifier may appear duplicated in mux/demux table (e.g., two entries with the same port identifier), indicating that the new port identifier may be translated to a third port identifier.

SIG service 538 may transmit a response to network 510. The new port identifier and source IP address may be used as a lookup key in the mux/demux table. For a successful lookup, the result will indicate the VPN identifier and a flag to indicate if this port has been translated. If it is translated, edge router 502 may retrieve the source port identifier from port table 532 and use it for port translation of the full IP packet.

FIG. 6 illustrates an example diagram of a multi-tenanted network utilizing a unique transport VPN for each tenant of the network according to some aspects of the present disclosure. System 600 may route traffic from tenants (e.g., tenant 614 and tenant 630) to network 616 via edge router 602. For example, requests to access a SIG service (e.g., SIG service 632 and/or SIG service 640) originating from tenant 614 may be routed through transport VPN 608 and transmitted to a respective SIG service via tunnel 636. Traffic from network 610 and network 612 may be transmitted through first VPN 604 and second VPN 606, respectively. As another example, requests to access a SIG service originating from tenant 630 may be routed through transport VPN 624 and transmitted to a respective SIG service via tunnel 638. Traffic from network 626 and network 628 may be transmitted through third VPN 620 and fourth VPN 622, respectively. In this scenario, a transport VPN may transmit traffic associated with one tenant. This provides segmentation for each tenant. However, to ensure segmentation for each segment of the tenant (e.g., between network 610 and network 612), a mux/demux table may be maintained per transport VPN. For example transport VPN 608 may maintain a mux/demux table and transport VPN 624 may maintain a mux/demux table. This may reduce collisions between segments of the tenant.

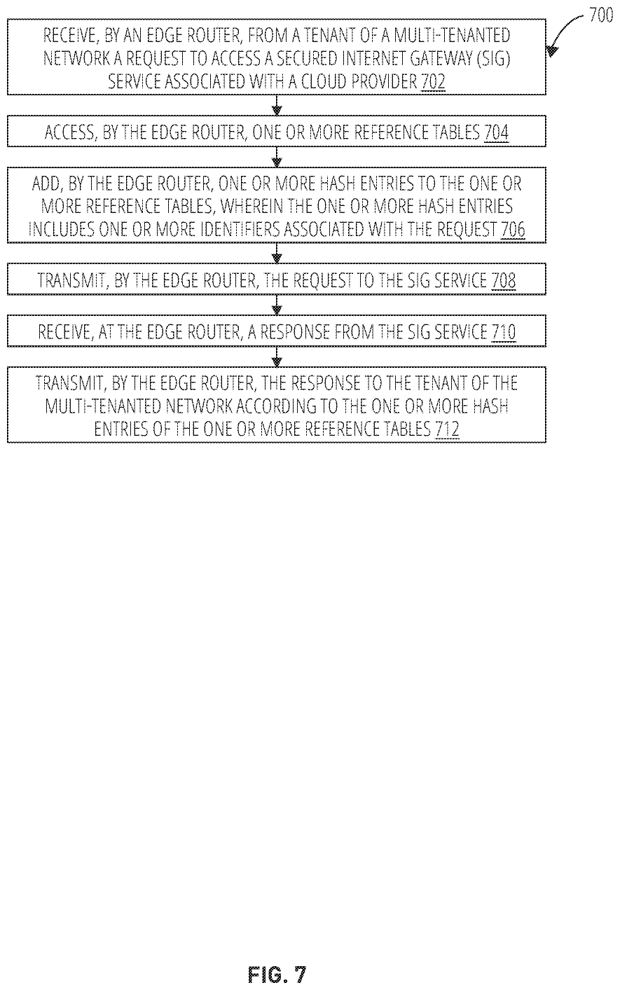

FIG. 7 illustrates an example routine for maintaining segmentation in a multi-tenanted network according to some aspects of the present disclosure. Although the example routine 700 depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the router may perform functions at substantially the same time or in a specific sequence.

In block 702, an edge router receives, from a tenant of a multi-tenanted network a request to access a Secured Internet Gateway (SIG) service associated with a cloud provider. For example, edge router 202 may receive a request to access SIG service 218 from network 210. SIG service 218 may be associated with a cloud provider, which may be connected to a network (e.g., network 210 as described in FIG. 2). The tenant of the multi-tenanted network may be an enterprise, a building, a client, a private browsing network, any combination thereof, or the like.

In block 704, the edge router accesses one or more reference tables. For example, edge router 202 may reference one or more mux/demux tables that may contain one or more hash entries associated with traffic transmitted on the multi-tenanted network. The reference tables may be stored in a location accessible to the edge router, such as local storage, private cloud storage, public cloud storage, any combination thereof, or the like.

In block 706, the edge router adds one or more hash entries to the one or more reference tables, wherein the one or more hash entries includes one or more identifiers associated with the request. For example, edge router 202 may add one or more hash entries to the one or more reference tables, and the hash entries may include a source IP address and a transport tunnel identifier (e.g., a reference to tunnel 240 as described in FIG. 2). The one or more hash entries may be a hash entry generated using a hashing algorithm, including, but not limited to, Message Digest (MD) 5, Secure Hash Algorithm (SHA) 1, SHA-2, Microsoft LAN Manager, NTLM, or a hashing function, such as the division method, the mid square method, the folding method, and the multiplication method.

In block 708, the edge router transmits the request to the SIG service. For example, edge router 202 may transmit the request to SIG service 218. The request may be transmitted using an associated transport tunnel (e.g., tunnel 240). In block 710, the edge router receives a response from the SIG service. For example, SIG service 218 may transmit the response to edge router 202 via tunnel 240. In block 712, the edge router transmits the response to the tenant of the multi-tenanted network according to the one or more hash entries of the one or more reference tables.

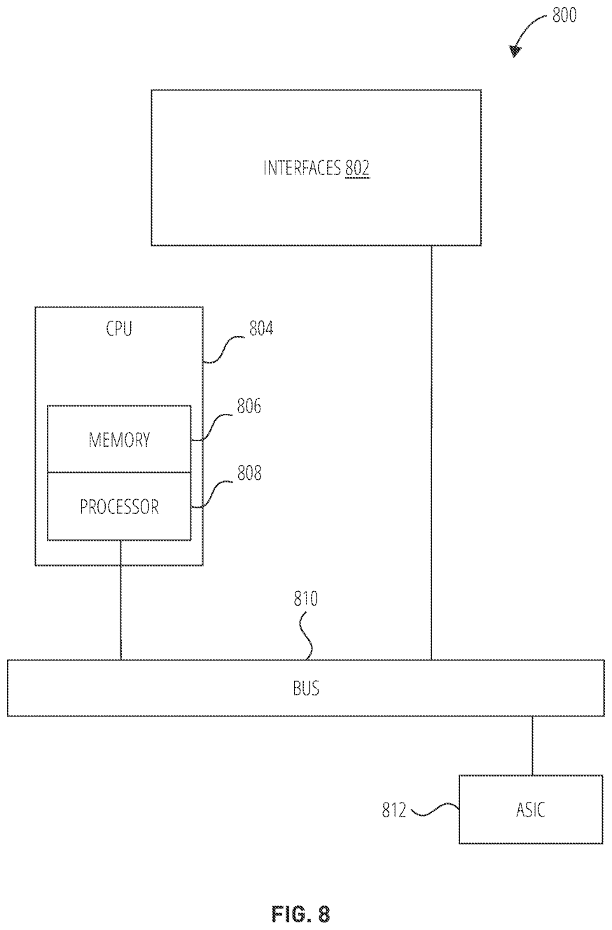

FIG. 8 illustrates an example network device 800 suitable for performing switching, routing, load balancing, and other networking operations according to some aspects of the present disclosure. The example network device 800 can be implemented as switches, routers, nodes, metadata servers, load balancers, client devices, and so forth.

Network device 800 includes a central processing unit (CPU) 804, interfaces 802, and a bus 810 (e.g., a PCI bus). When acting under the control of appropriate software or firmware, the CPU 804 is responsible for executing packet management, error detection, and/or routing functions. The CPU 804 preferably accomplishes all these functions under the control of software including an operating system and any appropriate applications software. CPU 804 may include one or more processors 808, such as a processor from the INTEL X86 family of microprocessors. In some cases, processor 808 can be specially designed hardware for controlling the operations of network device 800. In some cases, a memory 806 (e.g., non-volatile RAM, ROM, etc.) also forms part of CPU 804. However, there are many different ways in which memory could be coupled to the system.

The interfaces 802 are typically provided as modular interface cards (sometimes referred to as “line cards”). Generally, they control the sending and receiving of data packets over the network and sometimes support other peripherals used with the network device 800. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LORA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., 804) to efficiently perform routing computations, network diagnostics, security functions, etc.

Although the system shown in FIG. 8 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 800.

Regardless of the network device's configuration, it may employ one or more memories or memory modules (including memory 806) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 806 could also hold various software containers and virtualized execution environments and data.

The network device 800 can also include an application-specific integrated circuit (ASIC) 812, which can be configured to perform routing and/or switching operations. The ASIC 812 can communicate with other components in the network device 800 via the bus 810, to exchange data and signals and coordinate various types of operations by the network device 800, such as routing, switching, and/or data storage operations, for example.

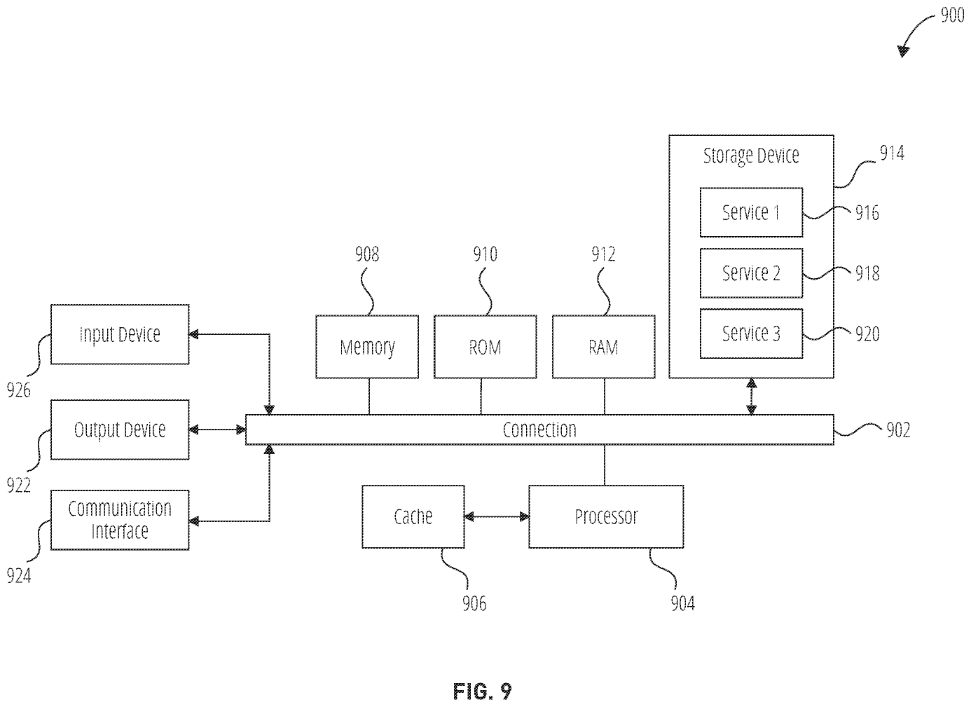

FIG. 9 shows an example of computing system 900, which can be for example any computing device making up the systems of a multi-tenanted network described throughout this disclosure, or any component thereof in which the components of the system are in communication with each other using connection 902. Connection 902 can be a physical connection via a bus, or a direct connection into processor 904, such as in a chipset architecture. Connection 902 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU or processor) 904 and connection 902 that couples various system components including system memory 908, such as read-only memory (ROM) 910 and random access memory (RAM) 912 to processor 904. Computing system 900 can include a cache of high-speed memory 906 connected directly with, in close proximity to, or integrated as part of processor 904.

Processor 904 can include any general purpose processor and a hardware service or software service, such as services 916, 918, and 920 stored in storage device 914, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method for differentiated multi-segmented cloud security, comprising:
receiving, by an edge router, from a tenant of a multi-tenanted network a request to access a Secured Internet Gateway (SIG) service associated with a cloud provider;
accessing, by the edge router, one or more reference tables;
adding, by the edge router, one or more hash entries to the one or more reference tables, wherein the one or more hash entries includes one or more identifiers associated with the request;
transmitting, by the edge router, the request to the SIG service;
receiving, at the edge router, a response from the SIG service; and
transmitting, by the edge router, the response to the tenant of the multi-tenanted network according to the one or more hash entries of the one or more reference tables.

2. The computer-implemented method of claim 1, wherein the request is transmitted through a unique transport tunnel, and the one or more identifiers include at least a source Internet Protocol (IP) address and a transport tunnel identifier.

3. The computer-implemented method of claim 1, wherein the request is transmitted through a high availability (HA) transport tunnel pair, and the one or more identifiers include at least an HA transport tunnel pair identifier.

4. The computer-implemented method of claim 1, wherein the request is transmitted through a common transport tunnel, and the one or more reference tables include a port entry translate table.

5. The computer-implemented method of claim 1, wherein the one or more reference tables are maintained for a transport virtual private network (VPN) transmitting the request to the SIG service.

6. The computer-implemented method of claim 1, wherein the one or more hash entries are removed from the one or more reference tables after a duration of time.

7. The computer-implemented method of claim 1, wherein the one or more hash entries are added to the one or more reference tables using a multiplexer.

8. The computer-implemented method of claim 1, wherein the one or more hash entries are extracted from the one or more reference tables using a demultiplexer.

9. A system comprising:
one or more processors; and
a memory storing instructions that, when executed by the one or more processors, configure the system to:
receive, by an edge router, from a tenant of a multi-tenanted network a request to access a Secured Internet Gateway (SIG) service associated with a cloud provider;
access, by the edge router, one or more reference tables;
add, by the edge router, one or more hash entries to the one or more reference tables, wherein the one or more hash entries includes one or more identifiers associated with the request;
transmit, by the edge router, the request to the SIG service;
receive, at the edge router, a response from the SIG service; and
transmit, by the edge router, the response to the tenant of the multi-tenanted network according to the one or more hash entries of the one or more reference tables.

10. The system of claim 9, wherein the request is transmitted through a unique transport tunnel, and the one or more identifiers include at least a source Internet Protocol (IP) address and a transport tunnel identifier.

11. The system of claim 9, wherein the request is transmitted through a high availability (HA) transport tunnel pair, and the one or more identifiers include at least an HA transport tunnel pair identifier.

12. The system of claim 9, wherein the request is transmitted through a common transport tunnel, and the one or more reference tables include a port entry translate table.

13. The system of claim 9, wherein the one or more reference tables are maintained for a transport virtual private network (VPN) transmit the request to the SIG service.

14. The system of claim 9, wherein the one or more hash entries are removed from the one or more reference tables after a duration of time.

15. The system of claim 9, wherein the one or more hash entries are added to the one or more reference tables using a multiplexer.

16. The system of claim 9, wherein the one or more hash entries are extracted from the one or more reference tables using a demultiplexer.

17. A non-transitory computer-readable storage medium, the non-transitory computer-readable storage medium including instructions that when executed by a computer, cause the computer to:
receive, by an edge router, from a tenant of a multi-tenanted network a request to access a Secured Internet Gateway (SIG) service associated with a cloud provider;
access, by the edge router, one or more reference tables;
add, by the edge router, one or more hash entries to the one or more reference tables, wherein the one or more hash entries includes one or more identifiers associated with the request;
transmit, by the edge router, the request to the SIG service;
receive, at the edge router, a response from the SIG service; and
transmit, by the edge router, the response to the tenant of the multi-tenanted network according to the one or more hash entries of the one or more reference tables.

18. The non-transitory computer-readable storage medium of claim 17, wherein the request is transmitted through a unique transport tunnel, and the one or more identifiers include at least a source Internet Protocol (IP) address and a transport tunnel identifier.

19. The non-transitory computer-readable storage medium of claim 17, wherein the request is transmitted through a high availability (HA) transport tunnel pair, and the one or more identifiers include at least an HA transport tunnel pair identifier.

20. The non-transitory computer-readable storage medium of claim 17, wherein the request is transmitted through a common transport tunnel, and the one or more reference tables include a port entry translate table.
